(19) United States
(12) Patent Application Publication
(10) Pub. No.: US 2004/0146176 A1
(43) Pub. Date: Jul. 29, 2004

(54) Paper-honeycomb-paper sandwich multi-layer loudspeaker cone structure

(75) Inventor: Wei-Chung Wu, Taipei (TW)

Correspondence Address: TROXELL LAW OFFICE PLLC, SUITE 1404, 5205 LEESBURG PIKE, FALLS CHURCH, VA, 22041, US

(73) Assignee: Meiloon Industrial Co., Ltd.

(21) Appl. No.: 10/350,113

(22) Filed: Jan. 24, 2003

(51) Int. Cl. H04R 1/00; H04R 9/06; H04R 11/02

(52) U.S. Cl. 381/425

(57) ABSTRACT

A paper-honeycomb-paper sandwich multi-layer loudspeaker cone structure comprises a first paper cone and a second paper cone, and a honey-comb core structure made of Nomex or aluminum material and disposed between the first and second paper cones; the honey-comb core structure is glued with the first and second paper cones by coating a resin on the surface of the interface between the first and second paper cones bonded the honeycomb core in between to constitute the multi-layer loudspeaker cone structure. The material application and improved structure of the multi-layer speaker make the entire set of loudspeaker cone light in weight and excellent in internal loss for the paper material inside, and thus significantly improving the rigidity of the loudspeaker cone and enhancing its performance.

### BACKGROUND OF THE INVENTION

1. Field of the Invention

The present invention relates to an improved loudspeaker cone structure, more particularly, to a paper-honeycomb-paper sandwich multi-layer loudspeaker cone structure comprising an upper layer cone body and a lower layer cone body which are made of paper and a high rigid honeycomb core bonded in between.

2. Description of the Prior Art

In general, the conical cone is one of the most common forms of loudspeakers and is typically manufactured of paper pulp or high molecule plastic polymers. It is generally considered the weakest link in the audio reproduction system. The audio sound spectrum contains widely different frequencies in the range of 20 Hz to 20 KHz, and when alternating currents of those frequencies are applied to the common conical loudspeaker, the cone will vibrate in different modes of lower and higher order. At lower frequencies, the conical cone vibrates as relatively rigid body, and correspondingly distortion remains low. However, the common conical cone is not rigid enough to withstand the inertia forces that occur at higher frequencies. As a result, when higher frequencies audio signals are applied to the common conical cone, it starts to vibrate not as one unit, but in part, causing correspondingly increased distortion in reproduced sound.

Therefore, many design efforts have focused on increasing the rigidity and reducing the weight of the common conical loudspeaker cone. In that regard, it is known that the most desirable characteristics of materials used for the loudspeaker cone are high modulus E, low density p, moderate internal loss and low overall weight. A large value of the ratio E/p is desirable to extend the high frequency limit and to reduce harmonic distortion.

There are shortcomings about the high-priced material having these properties such as boron nitrides or graphite, which makes the procedure of mass production impractical. The material such as fiberglass, Kevlar, and cloth used in the prior art loudspeaker is formed after dipping, but the cost of such materials is higher, and the weight is heavier, and thus the efficiency is relatively less.

In view of the shortcomings of the prior art, the inventor of the present invention based on years of experience in the related industry conducted extensive research to resolve the aforementioned problem and invented the present invention.

### SUMMARY OF THE INVENTION

It is therefore an object of this invention is to provide an improved paper-honeycomb-paper sandwich multi-layer cone for use in a loudspeaker system.

It is an another object of the invention is provide an improved paper-honeycomb-paper sandwich multi-layer cone having high rigidity moderate internal loss characteristics and low overall weight, but that can still be efficiently mass produced with readily available materials.

It is an another object of the invention is provide an improved paper-honeycomb-paper sandwich multi-layer cone having light weight but strong composite sandwich construction.

It is an another object of the invention is provide an improved paper-honeycomb-paper sandwich multi-layer cone manufacturing in low cost.

To accomplish the foregoing object, the paper-honeycomb-paper sandwich multi-layer loudspeaker cone structure of the present invention comprises a first layer paper cone and a second layer paper cone, and a honey-comb core structure is formed by Nomex or aluminum material disposed in the middle between the first layer and the second layer paper cones. A multi-layer loudspeaker cone is formed by means of coating and gluing resin between the interfaces of the first layer and second layer paper cones bonded the honeycomb core in between. The improved material, assembly, application, and structure of the loudspeaker make the multi-layer loudspeaker cone lighter in weight, better in internal loss, and also can significantly enhance the rigidity of the cone and improve its efficiency.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the disassembled structure the loudspeaker cone of the present invention.

FIG. 2 is a perspective diagram of the assembled structure of the loudspeaker cone of the present invention.

FIG. 3 is a cross-sectional diagram of an enlarged section of the present invention.

FIG. 4 is an illustrative diagram of manufacture of the present invention.

### DETAILED DESCRIPTION OF THE PREFERRED EMBODIMENTS

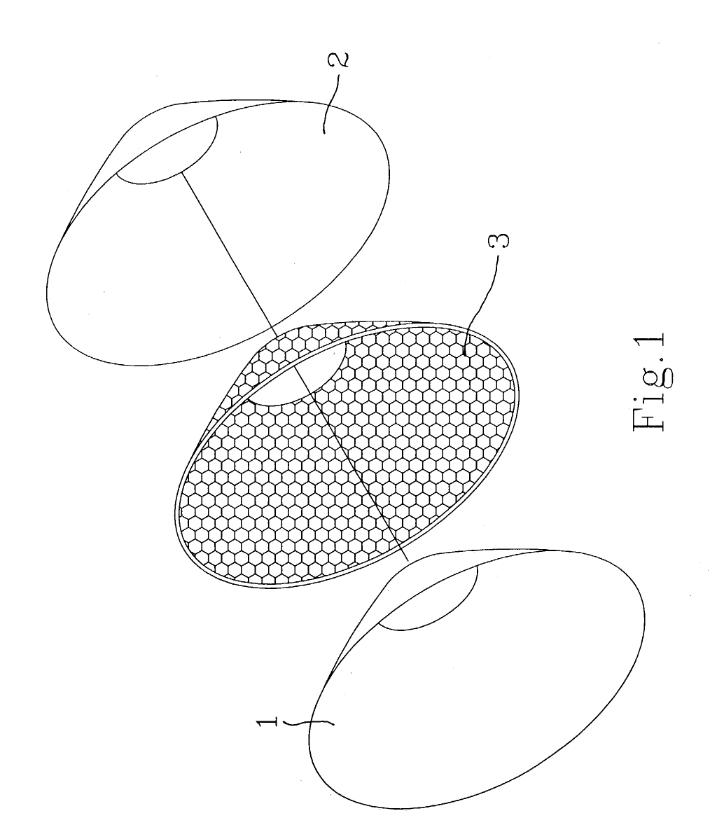

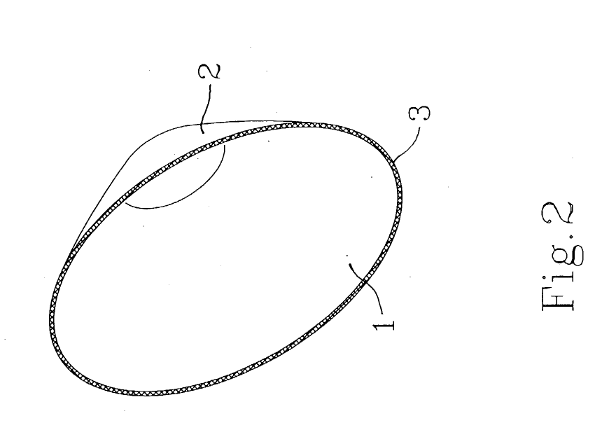

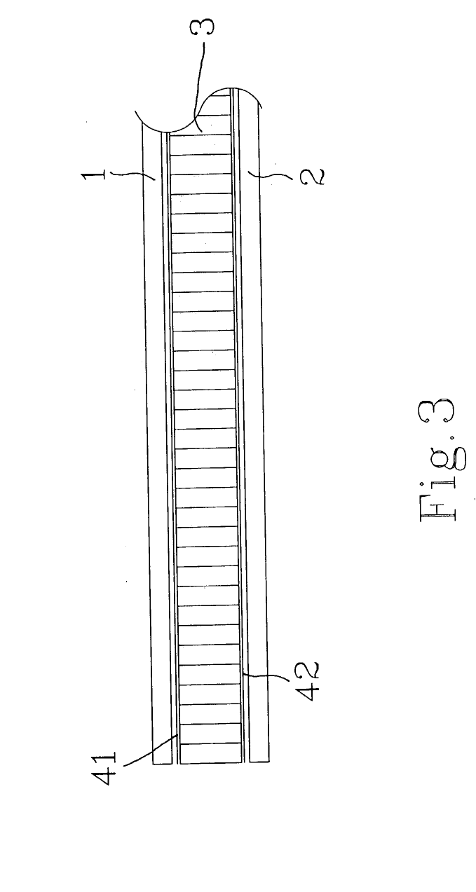

Please refer to FIGS. 1 to 4 for a paper-honeycomb-paper sandwich multi-layer loudspeaker cone structure of the present invention, which comprises a first paper cone 1, substantially in a bowl-conical shape with an opening on each of its ends, and disposed on the inner side of the loudspeaker cone; a second paper cone 2, substantially in a bowl-conical shape with an opening on each of its ends, and disposed on the outer side of the loudspeaker cone; a middle honeycomb core 3, substantially in a bowl-conical shape, and disposed in the middle between the first paper cone 1 and the second paper cone 2; a first glued layer 41, disposed between the first paper cone 1 and the middle core 3 for coupling; and a second glued layer 42, disposed between the second paper cone 2 and the middle core 3 for coupling.

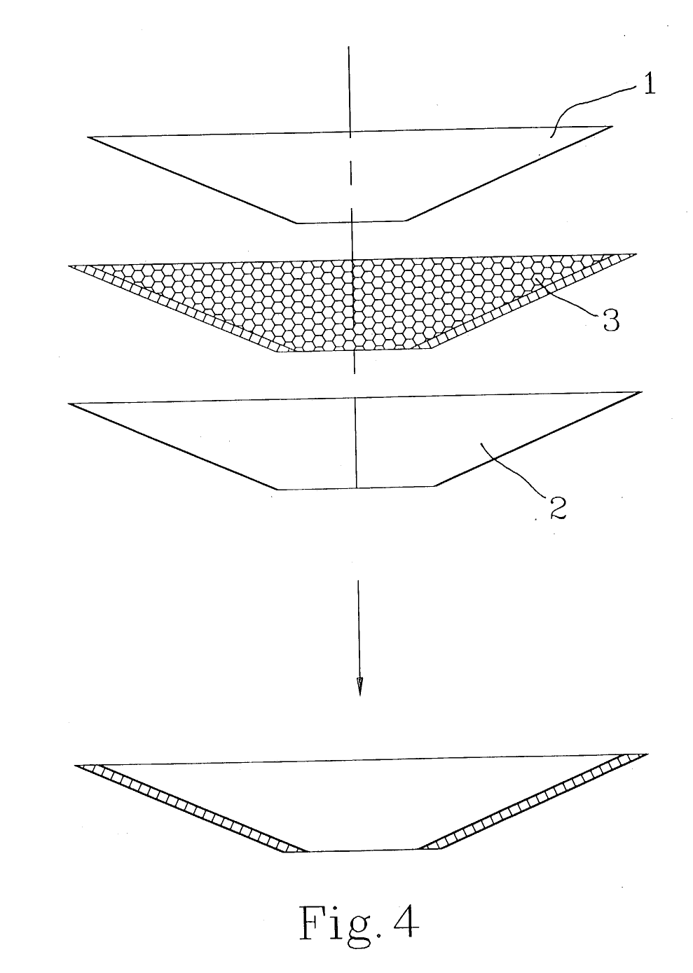

Please refer to FIGS. 1 and 4. The taper of the second paper cone 2 is larger than the taper of the middle honeycomb core 3 which in turn is larger than the taper of the first paper cone 1, and the three elements are stacked, glued, and trimmed to constitute the present invention.

In the manufacturing of the loudspeaker cone, after the first paper cone 1 and the second paper cone 2 are individually coated with glued, thermally pressed, and formed, the middle honeycomb core 3 is glued in a mold to produce the multi-layer loudspeaker cone structure.

The three elements are glued and coupled to form an integral loudspeaker cone, which not only has light weight and excellent internal loss, but also can significantly improve the rigidity of the loudspeaker cone and enhance its efficiency. It is noteworthy that the present invention makes use of a reasonable price to replay the sound from the loudspeaker, without causing distortion to the sound as the common conventional single-sheet paper products do.

In view of the above description, the present invention can definitely use a reasonable cost to overcome the shortcomings of the conventional single-sheet loudspeaker, provide a better performance over the prior art, comply with the patent application requirements, and is submitted to the Patent and Trademark Office for review and granting of the commensurate patent rights.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. A paper-honeycomb-paper sandwiched multi-layer loudspeaker cone structure, comprising of a first paper cone, substantially in a bowl-conical shape with an opening on each of its ends, and disposed on the inner side of the loudspeaker cone;
a second paper cone, substantially in a bowl-conical shape with an opening on each of its ends, and disposed on the outer side of the loudspeaker cone;
a middle honeycomb core, substantially in a bowl-conical shape, and disposed in the middle of the first paper cone and the second paper cone;
a first glued layer, disposed between the first paper cone and the middle core for their coupling;
a second glued layer, disposed between the second paper cone and the middle core for their coupling;
wherein the taper of the second paper cone is larger than the taper of the middle core which in turn is larger than the taper of the first paper cone, and the first and second paper cones and the middle cone are integrally coupled to form an integral loudspeaker cone possessing light weight, excellent internal loss which significantly improves the rigidity of the loudspeaker cone and enhances its efficiency.

2. A paper-honeycomb-paper sandwiched multi-layer loudspeaker cone structure as claimed in claim 1, wherein said first paper cone and second paper cone are individually coated with glue, thermally pressed, and formed, and then the middle honeycomb core is glued in a mold to produce the multi-layer loudspeaker cone structure.
